(19) United States
(12) Patent Application Publication
(10) Pub. No.: US 2026/0139490 A1
(43) Pub. Date: May 21, 2026

(54) DEVICE AND METHOD OF MULTIDIMENSIONAL PLATE ALIGNMENT

(71) Applicant: Simon Luis BIELER, Nahariya (IL)

(72) Inventor: Simon Luis BIELER, Nahariya (IL)

(21) Appl. No.: 19/392,202

(22) Filed: Nov. 18, 2025

(30) Foreign Application Priority Data
Nov. 19, 2024 (IL) 317190

(51) Int. Cl. E04F 11/18

(52) U.S. Cl. CPC E04F 11/1812; E04F 11/1853; E04F 2011/1895

(57) ABSTRACT

A cassette device for multidimensional plate alignment, an assembly of the device, plate and U-shaped anchoring profile and respective method of multidimensional plate alignment are described; the cassette device includes a superior anterior slider, superior posterior slider, inferior anterior slider and inferior posterior slider, mounted onto a superior anterior rail, superior posterior rail, inferior anterior rail and inferior posterior rail; the method includes horizontally offsetting, performing longitudinal inclination and performing vertical tilt of the plate in the U-shaped anchoring profile by the cassette device.

### TECHNICAL FIELD

In general, the present invention pertains to the art of mechanics. In particular, the invention relates to device and method of multidimensional plate alignment, including offsetting as well as inclinations about two different geometrical planes.

### BACKGROUND ART

It is believed that the current state of the art is represented by the following patent literature: U.S. Pat. Nos. 11,220,823, 9,657,760, 6,658,778, US20190301168, US20180135669 US20170101784, US20160298337 and US20150330562.

U.S. Pat. No. 11,220,823 that is believed to represent the closest prior art discloses a plate stabilizing device configured to couple with an external U-shaped anchoring profile. The device of U.S. Pat. No. 11,220,823 includes an external segment, corresponding in shape to the external U-shaped anchoring profile and configured to fit therein. The external segment in U.S. Pat. No. 11,220,823 includes a socket adapted to at least partially accommodate an external alignment tool through a passage serving as a turning point for the external alignment tool, and an internal segment that is configured to accommodate a bottom portion of the plate. The internal segment in U.S. Pat. No. 11,220,823 comprising an alignment tool wedge-like portion capable of accommodating a tip of the alignment tool.

### SUMMARY OF THE INVENTION

The following summary of the invention is provided to exhibit the basic understanding of some principles, underlying various aspects and features of the invention. This summary is not an extensive overview of the invention and as such it is not necessarily intended to particularly identify all key or critical elements of the invention and is not to delineate the scope of the invention. Its sole purpose is to present some concepts of the invention in a simplified form as a prelude to the following more detailed.

The invention was made in view of the deficiencies of the prior art and provides systems, methods and processes for overcoming these deficiencies. According to some embodiments and aspects of the present invention, there is provided a cassette device for multidimensional plate alignment that includes: a structural framework made of an essentially rigid material including: an anterior vertical member, extending essentially an entire height on an anterior side of the structural framework; a posterior vertical member, extending essentially an entire height on a posterior side of the structural framework; a median member, extending essentially an entire height in a center of the structural framework; a superior anterior rail, extending essentially in-between the median member and the anterior member, at a superior portion of the structural framework, the superior anterior rail embodies a slanted profile, in which one terminal portion of the superior anterior rail has a thickness substantially exceeding the thickness of another terminal portion of the superior anterior rail; a superior posterior rail, extending essentially in-between the median member and the posterior member, at a superior portion of the structural framework, the superior posterior rail has a slanted profile, in which one terminal portion of the superior posterior rail has a thickness substantially exceeding the thickness of another terminal portion of the superior posterior rail; an inferior anterior rail, extending essentially in-between the median member and the anterior member, at an inferior portion of the structural framework, the inferior anterior rail embodies a slanted profile, in which one terminal portion of the inferior anterior rail has a thickness substantially exceeding the thickness of another terminal portion of the inferior anterior rail; an inferior posterior rail, extending essentially in-between the median member and the posterior member, at an inferior portion of the structural framework, the inferior posterior rail embodies a slanted profile, in which one terminal portion of the inferior posterior rail has a thickness substantially exceeding the thickness of another terminal portion of the inferior posterior rail.

According to some embodiments and aspects of the present invention, a cassette device for multidimensional plate alignment includes: a superior anterior slider, configured to slide on the superior anterior rail, the superior anterior slider embodies a slanted profile, in which one terminal portion of the superior anterior slider has a thickness substantially exceeding the thickness of another terminal portion of the superior anterior slider, in which the slanted profile of the superior anterior slider is essentially inverted relative to the slanted profile of the superior anterior rail; a superior posterior slider, configured to slide on the superior posterior rail, the superior posterior slider embodies a slanted profile, in which one terminal portion of the superior posterior slider has a thickness substantially exceeding the thickness of another terminal portion of the superior posterior slider, in which the slanted profile of the superior posterior slider is essentially inverted relative to the slanted profile of the superior posterior rail; an inferior anterior slider, configured to slide on the inferior anterior rail, the inferior anterior slider embodies a slanted profile, in which one terminal portion of the inferior anterior slider comprises a thickness substantially exceeding the thickness of another terminal portion of the inferior anterior slider, in which the slanted profile of the inferior anterior slider is essentially inverted relative to the slanted profile of the inferior anterior rail; an inferior posterior slider, configured to slide on the inferior posterior rail, the inferior posterior slider embodies a slanted profile, in which one terminal portion of the inferior posterior slider comprises a thickness substantially exceeding the thickness of another terminal portion of the inferior posterior slider, in which the slanted profile of the inferior posterior slider is essentially inverted relative to the slanted profile of the inferior posterior rail.

In some embodiments, the superior and inferior anterior and posterior rails further comprise guide grooves, providing additional stability and preventing lateral movement of the superior and inferior anterior and posterior sliders. The slanted profiles of the superior and inferior anterior and posterior sliders are configured to provide a self-locking mechanism, ensuring that the sliders remain securely in place during use.

In some embodiments, the anterior vertical member, posterior vertical member and the median member further comprise an integrated scale, allowing for precise measurement of a multidimensional plate's position during alignment.

In some embodiments, the superior anterior rail, superior posterior rail, inferior anterior rail and the inferior posterior rail further comprise at least one end stopper, preventing the superior anterior slider, superior posterior slider, inferior anterior slider and the inferior posterior slider from sliding respectively off the superior anterior rail, superior posterior rail, inferior anterior rail and the inferior posterior rail.

According to some embodiments and aspects of the present invention, there is provided a method of multidimensional plate alignment comprises: providing a cassette device comprising: a structural framework made of an essentially rigid material comprising: an anterior vertical member, extending essentially an entire height on an anterior side of the structural framework; a posterior vertical member, extending essentially an entire height on a posterior side of the structural framework; a median member, extending essentially an entire height in a center of the structural framework; a superior anterior rail, extending essentially in-between the median member and the anterior member, at a superior portion of the structural framework, the superior anterior rail comprising a slanted profile, in which one terminal portion of the superior anterior rail comprises a thickness substantially exceeding the thickness of another terminal portion of the superior anterior rail; a superior posterior rail, extending essentially in-between the median member and the posterior member, at a superior portion of the structural framework, the superior posterior rail comprising a slanted profile, in which one terminal portion of the superior posterior rail comprises a thickness substantially exceeding the thickness of another terminal portion of the superior posterior rail; an inferior anterior rail, extending essentially in-between the median member and the anterior member, at an inferior portion of the structural framework, the inferior anterior rail comprising a slanted profile, in which one terminal portion of the inferior anterior rail comprises a thickness substantially exceeding the thickness of another terminal portion of the inferior anterior rail; an inferior posterior rail, extending essentially in-between the median member and the posterior member, at an inferior portion of the structural framework, the inferior posterior rail comprising a slanted profile, in which one terminal portion of the inferior posterior rail comprises a thickness substantially exceeding the thickness of another terminal portion of the inferior posterior rail. According to some embodiments and aspects of the present invention, the cassette device comprising: a superior anterior slider, configured to slide on the superior anterior rail, the superior anterior slider comprising a slanted profile, in which one terminal portion of the superior anterior slider comprises a thickness substantially exceeding the thickness of another terminal portion of the superior anterior slider, in which the slanted profile of the superior anterior slider is essentially inverted relative to the slanted profile of the superior anterior rail; a superior posterior slider, configured to slide on the superior posterior rail, the superior posterior rail comprising a slanted profile, in which one terminal portion of the superior posterior slider comprises a thickness substantially exceeding the thickness of another terminal portion of the superior posterior slider, in which the slanted profile of the superior posterior slider is essentially inverted relative to the slanted profile of the superior posterior rail; an inferior anterior slider, configured to slide on the inferior anterior rail, the inferior anterior rail comprising a slanted profile, in which one terminal portion of the inferior anterior slider comprises a thickness substantially exceeding the thickness of another terminal portion of the inferior anterior slider, in which the slanted profile of the inferior anterior slider is essentially inverted relative to the slanted profile of the inferior anterior rail; an inferior posterior slider, configured to slide on the inferior posterior rail, the inferior posterior rail comprising a slanted profile, in which one terminal portion of the inferior posterior slider comprises a thickness substantially exceeding the thickness of another terminal portion of the inferior posterior slider, in which the slanted profile of the inferior posterior slider is essentially inverted relative to the slanted profile of the inferior posterior rail.

According to some embodiments and aspects of the present invention, there is provided a method of multidimensional plate alignment that includes: providing a U-shaped anchoring profile; providing a plate; mounting the plate in the U-shaped anchoring profile; disposing a cassette device in-between the plate and the U-shaped anchoring profile; regulating a first degree of freedom in position of the plate relative to the U-shaped anchoring profile, by disposing the superior anterior slider and the superior posterior slider vis-à-vis the thicker portion of superior anterior rail and superior posterior rail, as well as disposing the inferior anterior slider and the inferior posterior slider vis-à-vis the thicker portion of the inferior anterior rail and the inferior posterior rail, so as to increase an operational thickness of the cassette device, thereby offsetting the plate away from the U-shaped anchoring profile.

According to some embodiments and aspects of the present invention, there is provided a method of multidimensional plate alignment that includes: providing a U-shaped anchoring profile; providing a plate; mounting the plate in the U-shaped anchoring profile; disposing a cassette device in-between the plate and the U-shaped anchoring profile; regulating a first degree of freedom in position of the plate relative to the U-shaped anchoring profile, disposing the superior anterior slider and the superior posterior slider vis-à-vis the thinner terminal portion of the superior anterior rail and the superior posterior rail, as well as disposing the inferior anterior slider and the inferior posterior slider vis-à-vis the thinner terminal portion of the inferior anterior rail and the inferior posterior rail, so as to decrease the operational thickness of the cassette device, thereby offsetting the plate towards the U-shaped anchoring profile.

According to some embodiments and aspects of the present invention, there is provided a method of multidimensional plate alignment that includes regulating a second degree of freedom in position of the plate relative to the U-shaped anchoring profile, by performing a vertical tilt of the plate, by disposing the superior anterior slider and the superior posterior slider vis-à-vis the thicker portion of the superior anterior rail and the superior posterior rail, as well as disposing the inferior anterior slider and the inferior posterior slider vis-à-vis the thinner terminal portion of the inferior anterior rail and the inferior posterior rail, so as to increase the operational thickness of an superior portion of the cassette device, whilst concomitantly to decrease the operational thickness of a inferior portion of the cassette device, thereby urging the plate for a vertical tilt away from the superior portion of the cassette device, about the vertical centerline of the U-shaped anchoring profile.

According to some embodiments and aspects of the present invention, there is provided a method of multidimensional plate alignment that includes regulating a second degree of freedom in position of the plate relative to the U-shaped anchoring profile, by performing a vertical tilt of the plate, by disposing the superior anterior slider and the superior posterior slider vis-à-vis the thinner terminal portion of the superior anterior rail and the superior posterior rail, as well as disposing the inferior anterior slider and the inferior posterior slider vis-à-vis the thicker terminal portion of the inferior anterior rail and the superior posterior rail, so as to decrease the operational thickness of the superior portion of the cassette device, whilst concomitantly to increase the operational thickness of the inferior portion of the cassette device, thereby urging the plate for a vertical tilt towards the superior portion of the cassette device, about the vertical centerline of the U-shaped anchoring profile.

According to some embodiments and aspects of the present invention, there is provided a method of multidimensional plate alignment that includes: regulating a third degree of freedom in position of said plate relative to said U-shaped anchoring profile, by performing a longitudinal inclination, by disposing respectively the superior anterior slider and the inferior anterior slider vis-à-vis the thicker terminal portion of the superior anterior rail and the inferior anterior rail, as well as disposing the superior posterior slider and the inferior posterior slider vis-à-vis the thinner terminal portion of the inferior anterior rail and the inferior posterior rail, so as to increase the operational thickness of the anterior portion of the cassette device, whilst concomitantly to decrease the operational thickness of an posterior portion of the cassette device, thereby urging the plate for a longitudinal inclination away from the anterior portion of the cassette device, about a longitudinal centerline of the U-shaped anchoring profile.

According to some embodiments and aspects of the present invention, there is provided a method of multidimensional plate alignment that includes: regulating a third degree of freedom in position of said plate relative to said U-shaped anchoring profile, by performing a longitudinal inclination, by disposing respectively the superior posterior slider and the superior anterior slider vis-à-vis the thicker terminal portion of the superior anterior rail and the inferior posterior rail, as well as disposing the inferior anterior slider and the inferior posterior slider vis-à-vis the thinner terminal portion of the superior anterior rail and the inferior anterior rail, to decrease the operational thickness of the anterior portion of the cassette device, whilst concomitantly to increase the operational thickness of the posterior portion of the cassette device, thereby urging the plate for a longitudinal inclination towards the anterior portion of the cassette device, about the longitudinal centerline of the U-shaped anchoring profile.

In some embodiments, the method further includes securing the plate in the U-shaped anchoring profile, by using fasteners to maintain alignment during operation.

In some embodiments, the method further includes connecting a biasing means to at least one of: the superior anterior slider, superior posterior slider, inferior anterior slider and the inferior posterior slider, to provide an increased friction and maintain a secure grip on the plate.

In some embodiments, the slanted profiles of the superior rails are oriented essentially invertedly, so that both first terminal portions of the superior rails are disposed either towards the median member or away from the median member.

In some embodiments, the slanted profiles of the inferior rails are oriented essentially invertedly, so that both first terminal portions of the inferior rails are disposed either towards the median member or away from the median member.

In some embodiments, the slanted profiles of the anterior rails are oriented essentially invertedly, so that first terminal portion of the superior anterior rail and the second portion of the superior anterior rail are disposed either towards the median member or towards the anterior member.

In some embodiments, the slanted profiles of the posterior rails are oriented essentially invertedly, so that first terminal portion of the superior posterior rail and the second portion of the superior posterior rail are disposed either towards the median member or towards the posterior member.

### DEFINITIONS

The term matching or a term similar thereto, as referred to herein, is to be construed as having a cross-sectional area and/or shape of a component equal or essentially similar to a cross-sectional area and/or shape of another component. It should be acknowledged that the components may only to be similar in the cross-sectional areas and/or shapes, to satisfy the term matching or similar, so long as the cross-sectional areas of the components can be mated and/or inserted into each other and/or the combination thereof essentially fits together and/or occupy essentially the same space.

The term structured, as referred to herein, is to be construed as including any geometrical shape, exceeding in complexity a plain linear shape or a shape embodying a simple and/or standardized circular, elliptical or polygonal contour or profile. Any more complex shape than a plain linear shape or a shape embodying a simple and/or standardized circular, elliptical or polygonal contour or profile, constitutes an example of structured geometry.

The term modular, as referred to herein, should be construed as a including a stand-alone and/or autonomically functioning of structured unit. The term modular inter alia means a standardized unit that may be conveniently installed or deployed without significant impact to the environment. The term modular, however, doesn't necessarily mean providing for ease of interchange or replacement. The term modular is optionally satisfied solely by providing for ease of onetime deployment or installation.

The terms connected, coupled, connectable and/or “in connection with” refer to any form of interaction between two or more entities, including mechanical, electrical, magnetic, electromagnetic, fluid, and thermal interactions. Components can be operatively coupled to each other even though they are not in direct contact with each other. The term “abutting” refers to items that are in direct physical contact with one another, although the items do not necessarily have to be attached to one another.

By operationally connected and operably coupled or similar terms used herein is meant connected in a specific way (e.g., in a manner allowing fluid to move and/or electric power or signal to be transmitted) that allows the disclosed system and its various components to operate effectively in the manner described herein.

The term readily connectable, as referred to herein, should be construed as including any structure and/or member that is configured to be conveniently connected to other structure and/or member and/or components of a larger system or assembly. The term readily connectable, however, doesn't necessarily mean readily disconnectable or removable. The term readily connectable is optionally satisfied by providing for ease of onetime connection or coupling.

The term fastener or a term similar thereto, as referred to herein, is to be construed as any suitable structure, material and/or device that effects an attachment, mounting and/or affixing, in a non-limiting manner including the examples of: bolts, screws, staples, pins, clips, magnetic couplings, zippers, snaps, magnets, non-permanent adhesives, adhesives, welding, nails, rivets, buckles, straps, stings, knots, hook and loop fasteners such as VELCRO®, which is a trademark registered to Velcro Industries B.V.

The term biasing means or alike, as referred to herein, should be construed as including any material, structure or mechanism, configured to accumulate mechanical energy, by changing the configuration thereof, upon a force exerted thereon, such as a compressive, tensile, shear or torsional force, as well as for releasing the energy accumulated therein, by returning to the normal or default configuration thereof and thereby performing a mechanical work, typically by linear or radial displacement. Examples of biasing means in a non-limiting manner include, springs, elastomers, leaf-springs, coil-springs, tension/extension spring, compression spring torsion spring, constant spring, variable spring, variable stiffness spring, flat spring, machined spring, serpentine spring, garter spring, cantilever spring, helical spring, hollow tubing springs, volute spring, V-spring, belleville washer or belleville spring, constant-force spring, gas spring, mainspring, negator spring, progressive rate coil springs, rubber band, spring washer and wave spring.

The terms firm rigid, or stiff, as referred to herein, are to be construed as having rigidity modulus value, otherwise referred to as the shear modulus, of 4800 MPa or more. Materials are considered to be firm rigid, or stiff but not tensile, when such materials are incapable of being efficiently elastically flexed or bent. Stiff materials, such as steel, are defined as having rigidity modulus value well exceeding 4800 MPa.

The terms pliable or pliant, as referred to herein, are to be construed as having high tensile strength and capable of being efficiently elastically flexed or bent but not being resilient and incapable of being efficiently stretched or expanded. The term tensile or tensile strength, as referred to herein, is to be construed inter alia as a shortcut of the known term ultimate tensile strength, frequently represented acronym as UTS, meaning an intensive property of a material or structure to withstand loads tending to elongate, namely to resist tension, defined as the maximum stress that a material can withstand while been stretched or pulled before sustaining breaking, substantial deformation and/or necking before fracture, such as nylon, relating to essentially non-ductile materials, having UTS value ranging between about 600 and 1000 MPa or more, but not including rigid, firm or stiff materials.

The terms elastic or resilient, as referred to herein, are to be construed as having tensile strength lower than aforesaid tensile strength of pliable or pliant material and optionally being capable of efficiently stretching or expanding, relating inter alia to essentially ductile materials, having UTS value lesser than about 600 MPa.

The terms method and process as used herein are to be construed as including any sequence of steps or constituent actions, regardless a specific timeline for the performance thereof. The particular steps or constituent actions of any given method or process are not necessarily in the order they are presented in the claims, description or flowcharts in the drawings, unless the context clearly dictates otherwise. Any particular step or constituent action included in a given method or process may precede or follow any other particular step or constituent action in such method or process, unless the context clearly dictates otherwise. Any particular step or constituent action and/or a combination thereof in any method or process may be performed iteratively, before or after any other particular step or action in such method or process, unless the context clearly dictates otherwise. Moreover, some steps or constituent actions and/or a combination thereof may be combined, performed together, performed concomitantly and/or simultaneously and/or in parallel, unless the context clearly dictates otherwise. Moreover, some steps or constituent actions and/or a combination thereof in any given method or process may be skipped, omitted, spared and/or opted out, unless the context clearly dictates otherwise.

In the specification or claims herein, any term signifying an action or operation, such as: a verb, whether in base form or any tense, gerund or present/past participle, is not to be construed as necessarily to be actually performed but rather in a constructive manner, namely as to be performed merely optionally or potentially.

The term substantially as used herein is a broad term, and is to be given its ordinary and customary meaning to a person of ordinary skill in the art (and is not to be limited to a special or customized meaning), and refers without limitation to being largely but not necessarily entirely of that quantity or quality which is specified.

The term essentially means that the composition, method or structure may include additional ingredients, stages and or parts, but only if the additional ingredients, the stages and/or the parts do not materially alter the basic and new characteristics of the composition, method or structure claimed.

As used herein, the term essentially changes a specific meaning, meaning an interval of plus or minus ten percent (±10%). For any embodiments disclosed herein, any disclosure of a particular value, in some alternative embodiments, is to be understood as disclosing an interval approximately or about equal to that particular value (i.e., ±10%).

As used herein, the terms about or approximately modify a particular value, by referring to a range equal to the particular value, plus or minus twenty percent (+/−20%). For any of the embodiments, disclosed herein, any disclosure of a particular value, can, in various alternate embodiments, also be understood as a disclosure of a range equal to about that particular value (i.e. +/−20%).

As used herein, the term or is an inclusive or operator, equivalent to the term and/or, unless the context clearly dictates otherwise; whereas the term and as used herein is also the alternative operator equivalent to the term and/or, unless the context clearly dictates otherwise.

It should be understood, however, that neither the briefly synopsized summary nor particular definitions hereinabove are not to limit interpretation of the invention to the specific forms and examples but rather on the contrary are to cover all modifications, equivalents and alternatives falling within the scope of the invention.

### DESCRIPTION OF THE DRAWINGS

The present invention will be understood and appreciated more comprehensively from the following detailed description taken in conjunction with the appended drawings in which:

FIG. 1 is a perspective view of a cassette device for multidimensional plate alignment, according to some embodiments of the present invention;

FIG. 2A is a perspective view of a cassette device for multidimensional plate alignment, according to some embodiments of the present invention;

FIG. 2B is an enlarged view of a superior anterior rail of a structural framework of the cassette device, according to some embodiments of the present invention;

FIG. 3A is an exploded anterior back perspective view of a cassette device with a superior anterior slider and an inferior anterior slider detached from the structural framework of the cassette device, according to some embodiments of the present invention;

FIG. 3B is an exploded posterior back perspective view of a cassette device with a superior posterior slider and a posterior anterior slider detached from the structural framework of the cassette device, according to some embodiments of the present invention;

FIG. 4 is a perspective view of an assembly of a plate and a cassette device in a U-shaped anchoring profile, according to some embodiments of the present invention;

FIG. 5A is a perspective view of a cassette device configured for regulating a first degree of freedom in position of a plate relative to a U-shaped anchoring profile, by increasing an operational thickness of the cassette device, according to some embodiments of the present invention;

FIG. 5B is a perspective view of an assembly of a plate and a cassette device in a U-shaped anchoring profile, regulating a first degree of freedom, by increasing an operational thickness of the cassette device and thus urging the plate away from the U-shaped anchoring profile, according to some embodiments of the present invention;

FIG. 6A is a perspective view of a cassette device configured for regulating a first degree of freedom in position of a plate relative to a U-shaped anchoring profile, by decreasing an operational thickness of the cassette device, according to some embodiments of the present invention;

FIG. 6B is a perspective view of an assembly of a plate and a cassette device in a U-shaped anchoring profile, regulating a first degree of freedom, by decreasing an operational thickness of the cassette device and thus urging the plate away towards the U-shaped anchoring profile, according to some embodiments of the present invention;

FIG. 7A is a perspective view of a cassette device configured for regulating a second degree of freedom in position of a plate relative to a U-shaped anchoring profile, by decreasing an operational thickness of an anterior portion of the cassette device, whilst concomitantly increasing the operational thickness of a posterior portion of a cassette device, according to some embodiments of the present invention;

FIG. 7B is a perspective view of an assembly of a plate and a cassette device in a U-shaped anchoring profile, regulating a second degree of freedom, by decreasing an operational thickness of the anterior portion, whilst concomitantly increasing the operational thickness of a posterior portion of a cassette device, thus urging a longitudinal inclination of the plate towards the anterior portion of the cassette device, according to some embodiments of the present invention;

FIG. 8A is a perspective view of a cassette device configured for regulating a second degree of freedom in position of a plate relative to a U-shaped anchoring profile, by increasing an operational thickness of an anterior portion of a cassette device, whilst concomitantly decreasing the operational thickness of a posterior portion of a cassette device according to some embodiments of the present invention;

FIG. 8B is a perspective view of an assembly of a plate and a cassette device in a U-shaped anchoring profile regulating a second degree of freedom, by increasing an operational thickness of an anterior portion of a cassette device, whilst concomitantly decreasing the operational thickness of a posterior portion, thus urging a longitudinal inclination of the plate away from the anterior portion of the cassette device, according to some embodiments of the present invention;

FIG. 9A is a perspective view of a cassette device with configured for regulating third degree of freedom in position of a plate relative to a U-shaped anchoring profile, by increasing an operational thickness of a superior portion of a cassette device, whilst concomitantly decreasing the operational thickness of an inferior portion of a cassette device, according to some embodiments of the present invention;

FIG. 9B is a perspective view of an assembly of a plate and a cassette device in a U-shaped anchoring profile regulating a third degree of freedom, by increasing an operational thickness of a superior portion of a cassette device, whilst concomitantly decreasing the operational thickness of an inferior portion of the cassette device, thus urging a vertical tilt of the plate away from the superior portion of the cassette device, according to some embodiments of the present invention;

FIG. 10A is a perspective view of a cassette device configured for regulating a third degree of freedom in position of a plate relative to a U-shaped anchoring profile, by decreasing an operational thickness of a superior portion of a cassette device, whilst concomitantly increasing the operational thickness of an inferior portion of the cassette device, according to some embodiments of the present invention;

FIG. 10B is a perspective view of an assembly of a plate and a cassette device in a U-shaped anchoring profile regulating a third degree of freedom, by decreasing an operational thickness of a superior portion of a cassette device, whilst concomitantly increasing the operational thickness of an inferior portion of the cassette device, thus urging a vertical tilt of the plate towards the superior portion of the cassette device, according to some embodiments of the present invention;

FIG. 11 is a flowchart of a method of multidimensional plate alignment, according to some embodiments of the present invention.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

Illustrative embodiments of the invention are described below. In the interest of clarity, not all features of actual implementation are described in this specification. It should be appreciated that various features or elements described in the context of some embodiment may be interchangeable with features or elements of any other embodiment described in the specification. Moreover, it will be appreciated that for the development of any actual embodiment, numerous implementation-specific decisions must be made to achieve the developers'specific goals, such as compliance with technology-or business-related constraints, which may vary from one implementation to another, and the effort of such a development might be complex and time-consuming, but would nevertheless be a routine undertaking for those of ordinary skill in the art having the benefit of this disclosure.

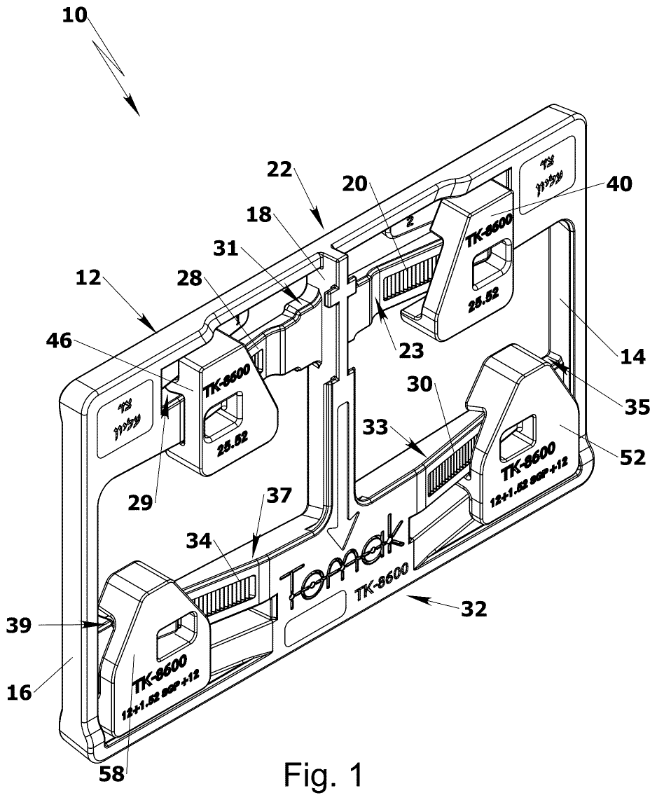

In accordance with some embodiments of the present invention, reference is now made to FIG. 1 to 3B, showing a perspective view of cassette device 10 for multidimensional plate alignment. In some embodiments, cassette device 10 comprises structural framework 12. Structural framework 12 is typically made of an essentially rigid material.

In some embodiments, structural framework 12 comprises anterior vertical member 14. Anterior vertical member 14 extends essentially an entire height on an anterior side of structural framework 12 or the anterior portion of cassette device 10. In some embodiments, structural framework 12 further comprises posterior vertical member 16. Posterior vertical member 16 extends essentially an entire height on a posterior side of structural framework 12 or the posterior portion of cassette device 10.

In some embodiments, structural framework 12 further comprises median member 18. Median member 18 extends essentially the entire height in a center of structural framework 12. Median member 18 essentially divides structural framework 12, into an anterior moiety and respectively opposing posterior moiety.

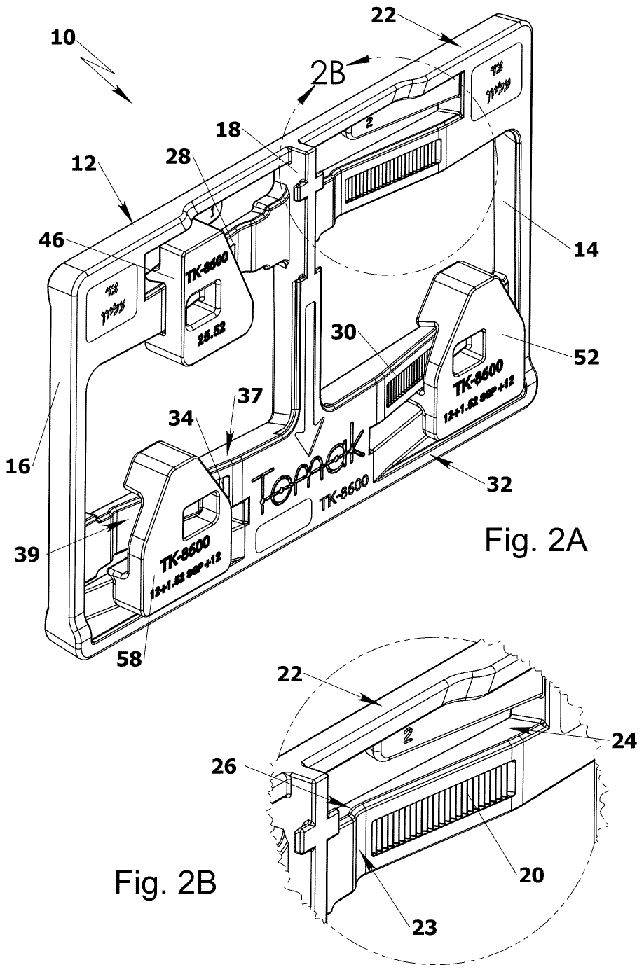

In some embodiments, structural framework 12 further comprises superior anterior rail 20. Superior anterior rail 20 extends essentially in-between median member 18 and anterior member 14, at superior portion 22 of structural framework 12. In some embodiments, such as shown in FIGS. 2A and 2B, superior anterior rail 20 comprises a slanted profile, in which first terminal portion 24 of superior anterior rail 20 comprises a thickness substantially exceeding the thickness of second terminal portion 26 of superior anterior rail 20.

In some embodiments, structural framework 12 further comprises superior posterior rail 28. Superior posterior rail 28 extends essentially in-between median member 18 and posterior member 16, at superior portion 22 of structural framework 12. In some embodiments, such as shown in FIG. 1, superior posterior rail 28 comprises a slanted profile, in which first terminal portion 29 of superior posterior rail 28 comprises a thickness substantially exceeding the thickness of second terminal portion 31 of superior posterior rail 28.

In some embodiments, structural framework 12 further comprises inferior anterior rail 30. Inferior anterior rail 30 extends essentially in-between median member 18 and anterior member 14, at inferior portion 32 of structural framework 12. In some embodiments, such as shown in FIG. 1, inferior anterior rail 30 comprises a slanted profile, in which first terminal portion 33 of inferior anterior rail 30 comprises a thickness substantially exceeding the thickness of second terminal portion 35 of inferior anterior rail 30.

In some embodiments, structural framework 12 further comprises inferior posterior rail 34. Inferior posterior rail 34 extends essentially in-between median member 18 and posterior member 16, at inferior portion 32 of structural framework 12. In some embodiments, such as shown in FIG. 1, inferior posterior rail 34 comprises a slanted profile, in which first terminal portion 37 of inferior posterior rail 34 comprises a thickness substantially exceeding the thickness of second terminal portion 39 of inferior posterior rail 34.

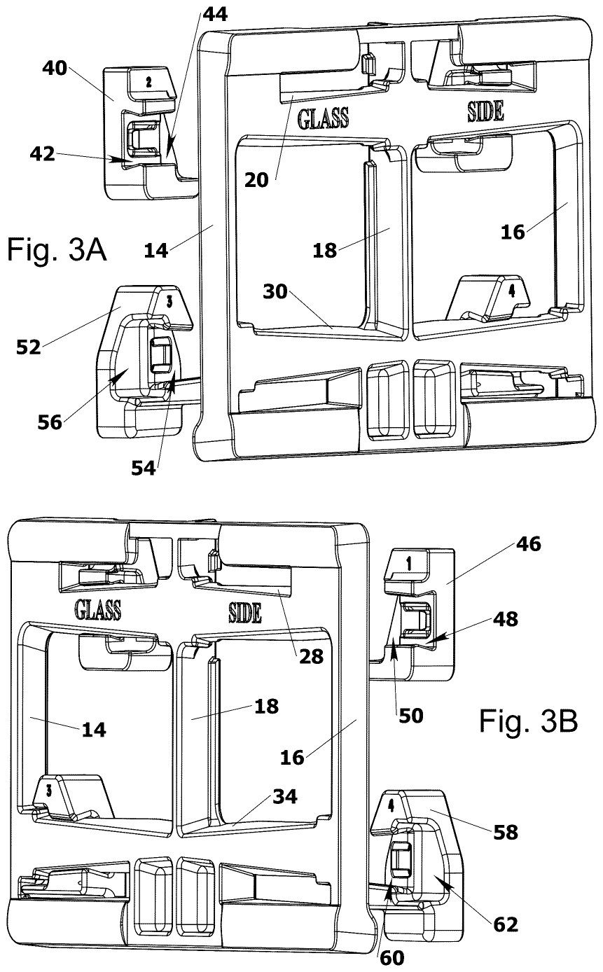

In some embodiments, cassette device 10 further comprises superior anterior slider 40. Superior anterior slider 40 is configured to slide on and along superior anterior rail 20. In some embodiments, as shown in FIG. 3A, superior anterior slider 40 comprises a slanted profile, in which first terminal portion 42 of superior anterior slider 40 comprises a thickness substantially exceeding the thickness of second terminal portion 44 of superior anterior slider 40. In some embodiments, the slanted profile of superior anterior slider 40 is oriented essentially invertedly relative to the slanted profile of superior anterior rail 20.

In some embodiments, cassette device 10 further comprises superior posterior slider 46. Superior posterior slider 46 is configured to slide on and along superior posterior rail 28. In some embodiments, superior posterior slider 46 comprises a slanted profile, in which first terminal portion 48 of superior posterior slider 46 comprises a thickness substantially exceeding the thickness of second terminal portion 50 of superior posterior slider 46. In some embodiments, the slanted profile of superior posterior slider 46 is oriented essentially invertedly relative to the slanted profile of superior posterior rail 28.

In some embodiments, cassette device 10 further comprises inferior anterior slider 52. Inferior anterior slider 52 is configured to slide on and along inferior anterior rail 30. In some embodiments, inferior anterior slider 52 comprises a slanted profile, in which first terminal portion 54 of inferior anterior slider 52 comprises a thickness substantially exceeding the thickness of second terminal portion 56 of inferior anterior slider 52. In some embodiments, the slanted profile of inferior anterior slider 52 is oriented essentially invertedly relative to the slanted profile of inferior anterior rail 30.

In some embodiments, cassette device 10 further comprises inferior posterior slider 58. Inferior posterior slider 58 is configured to slide on and along inferior posterior rail 34. In some embodiments, inferior posterior slider 58 comprises a slanted profile, in which first terminal portion 60 of inferior posterior slider 58 comprises a thickness substantially exceeding the thickness of second terminal portion 62 of inferior posterior slider 58. In some embodiments, the slanted profile of inferior posterior slider 58 is oriented essentially invertedly relative to the slanted profile of inferior posterior rail 34.

In some embodiments, such as shown in FIG. 2B, superior anterior rail 20, superior posterior rail 28, inferior anterior rail 30 and/or inferior posterior rail 34 further comprise plurality of guide grooves 21. Grooves 21 are configured to provide stability and preventing lateral movement of superior anterior slider 40, superior posterior slider 46, inferior anterior slider 52 and/or inferior posterior slider 58 relative to superior anterior rail 20, superior posterior rail 28, inferior anterior rail 30 and/or inferior posterior rail 34.

In some embodiments, the slanted profile of superior anterior slider 40, superior posterior slider 46, inferior anterior slider 52 and/or inferior posterior slider 58 comprise a self-locking mechanism, ensuring that superior anterior slider 40, superior posterior slider 46, inferior anterior slider 52 and/or inferior posterior slider 58 remain securely in place during use, on superior anterior rail 20, superior posterior rail 28, inferior anterior rail 30 and/or inferior posterior rail 34.

In some embodiments, superior anterior rail 20, superior posterior rail 28, inferior anterior rail 30 and/or inferior posterior rail 34 further comprise at least one end stopper 23, preventing superior anterior slider 40, superior posterior slider 46, inferior anterior slider 52 and/or inferior posterior slider 58 from sliding off superior anterior rail 20, superior posterior rail 28, inferior anterior rail 30 and/or inferior posterior rail 34.

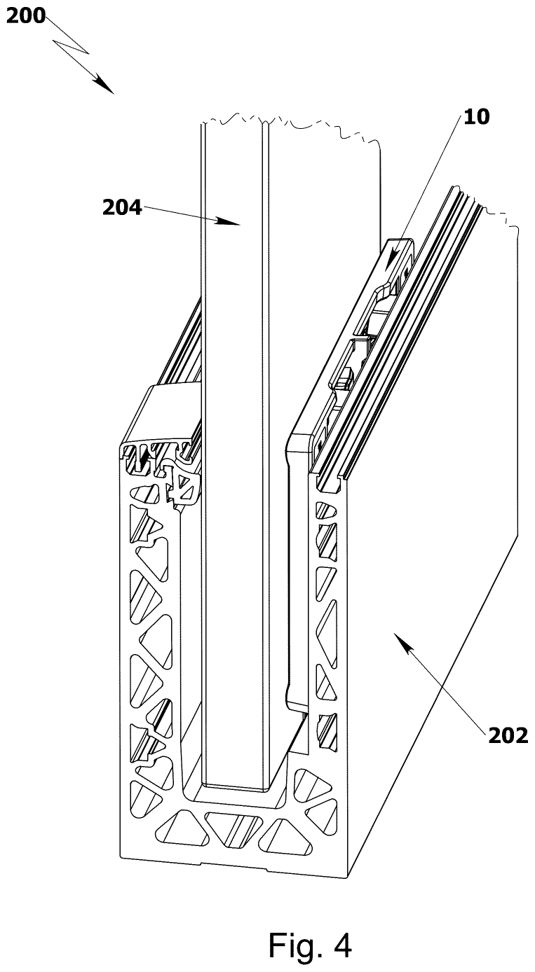

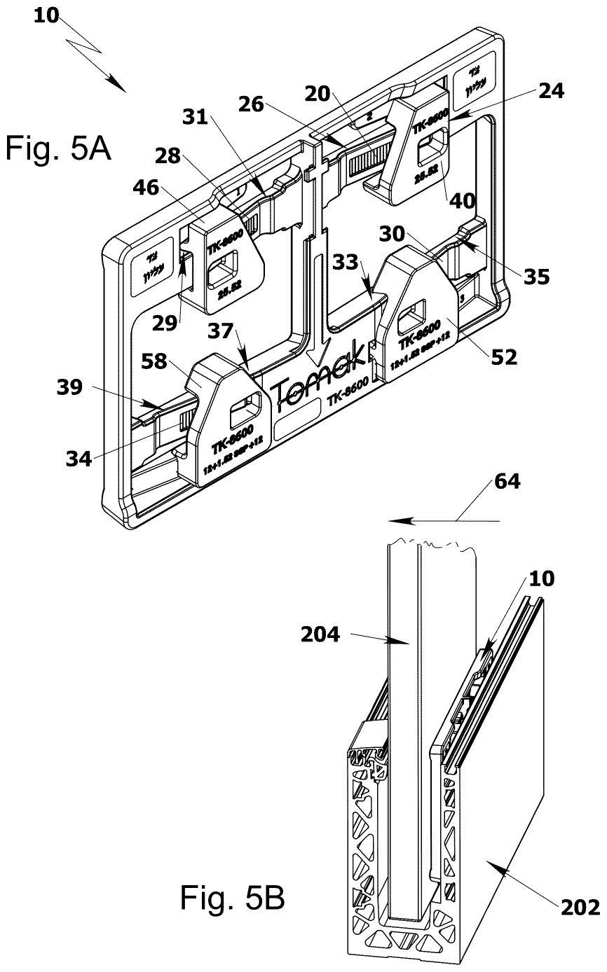

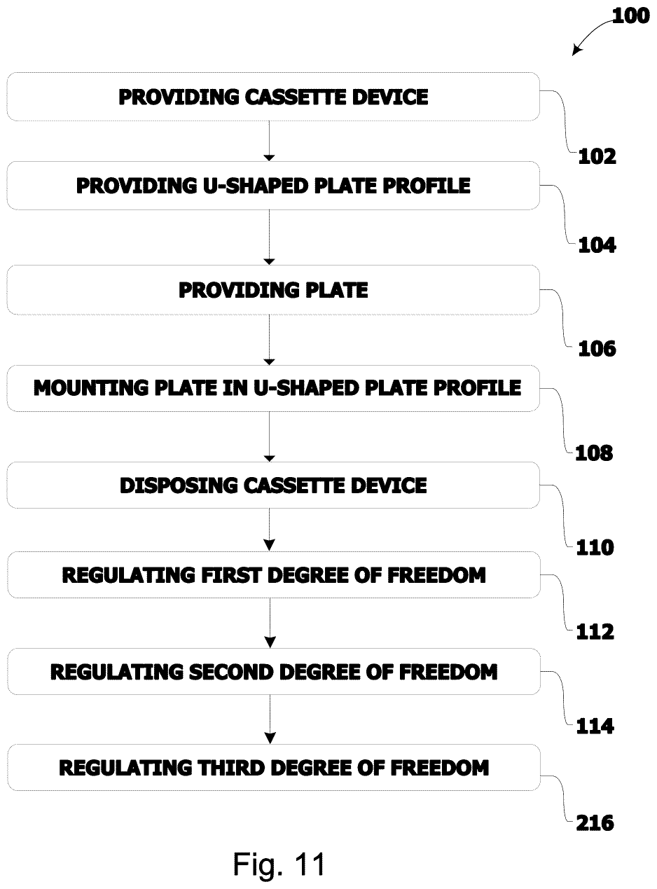

In accordance with some embodiments of the present invention, reference is now made to FIG. 4, showing assembly 200 of plate 204, typically a glass plate, cassette device 10 shown in FIG. 1, and U-shaped anchoring profile 202. Reference is further made to FIG. 5A to 10B, showing cassette device 10 with a various degrees of freedom in position of plate 204 relative to U-shaped anchoring profile 202, as well as to FIG. 11 showing a flowchart of method 100 of multidimensional plate alignment. The embodiment of FIG. 4 to 11 illustrates various features that may be interchangeable with elements of any other embodiment described in the specification.

In some embodiments, method 100 of multidimensional plate alignment commences at step 102 of providing a cassette device. In some embodiments, the cassette device, is essentially cassette device 10 shown in FIG. 1 to 3B, comprising a structural framework made of an essentially rigid material.

In some embodiments, the structural framework comprises an anterior vertical member, posterior vertical member, and a median member, similarly cassette device 10 shown in FIG. 1 to 3B.

In some embodiments, the structural framework further comprises a superior anterior rail, in which the first terminal portion of the superior anterior rail comprises a thickness substantially exceeding the thickness of the second terminal portion of the superior anterior rail. In some embodiments, the structural framework further comprises a superior posterior rail, in which the first terminal portion of the superior posterior rail comprises a thickness substantially exceeding the thickness of the second terminal portion of the superior posterior rail, similarly cassette device 10 shown in FIG. 1 to 3B.

In some embodiments, the structural framework further comprises an inferior anterior rail, in which the first terminal portion of the inferior anterior rail comprises a thickness substantially exceeding the thickness of the second terminal portion of the inferior anterior rail. In some embodiments, the structural framework further comprises an inferior posterior rail, in which the first terminal portion of the inferior posterior rail comprises a thickness substantially exceeding the thickness of the second terminal portion of the inferior posterior rail, similarly cassette device 10 shown in FIG. 1 to 3B.

In some embodiments, the cassette device, further comprises a superior anterior slider, superior posterior slider, inferior anterior slider, in which the first terminal portion of these sliders comprises a thickness substantially exceeding the thickness of the second terminal portion of these sliders. In some embodiments, the slanted profile of the sliders is essentially inverted relative to the slanted profile of the rails, similarly cassette device 10 shown in FIG. 1 to 3B.

In some embodiments, method 100 of multidimensional plate alignment further comprises to step 104 of providing a U-shaped anchoring profile, such as U-shaped anchoring profile 202 shown in FIG. 4. In some embodiments, method 100 of multidimensional plate alignment yet further comprises step 106 of providing a plate, such as plate 204 shown in FIG. 4.

In some embodiments, method 100 of multidimensional plate alignment proceeds to step 108 of mounting the plate in U-shaped anchoring profile. In some embodiments, method 100 of multidimensional plate alignment yet further proceeds to step 110 of disposing cassette device 10 in-between plate 204 and U-shaped anchoring profile 202, such as shown in FIG. 4.

In some embodiments, method 100 of multidimensional plate alignment further comprises step 112 of regulating a first degree of freedom in position of plate 204 relative to U-shaped anchoring profile 202. In some embodiments, such as shown in FIGS. 5A and 5B, to increase an operational thickness of cassette device 10, step 112 is achievable by disposing respectively superior anterior slider 40 and superior posterior slider 46 on first terminal portion 24 of superior anterior rail 20 and terminal portion 29 of superior posterior rail 28, so that superior anterior slider 40 and superior posterior slider 46 are disposed vis-à-vis first terminal portion 26 of superior anterior rail 20 and first terminal portion 31 of superior posterior rail 28.

In some embodiments, such as shown in FIGS. 5A and 5B, to increase an operational thickness of cassette device 10, step 112 is achievable by disposing respectively inferior anterior slider 52 and inferior posterior slider 58 on first terminal portion 33 of inferior anterior rail 30 and first terminal portion 37 of inferior posterior rail 34, so that so that inferior anterior slider 52 and inferior posterior slider 58 are disposed vis-à-vis first terminal portion 35 of inferior anterior rail 30 and first terminal portion 39 of inferior posterior rail 34.

In some embodiments, such as shown in FIGS. 5B and 5B, increasing an operational thickness of cassette device 10 facilitates the offsetting of plate 204 away from U-shaped anchoring profile 202 in the direction of arrow 64.

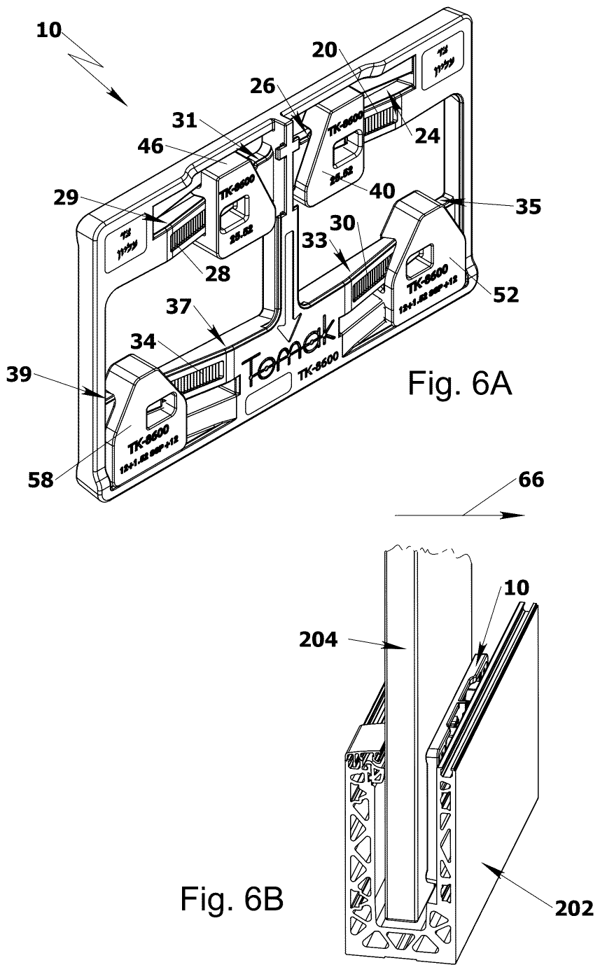

In some embodiments, such as shown in FIGS. 6A and 6B, to decrease the operational thickness of cassette device 10, step 112 is achievable by disposing respectively superior anterior slider 40 and superior posterior slider 46 on second terminal portion 26 of superior anterior rail 20 and second terminal portion 31 of superior posterior rail 28, so that so that superior anterior slider 40 and superior posterior slider 46 are disposed vis-à-vis second terminal portion 26 of superior anterior rail 20 and second terminal portion 31 of superior posterior rail 28.

In some embodiments, such as shown in FIGS. 6A and 6B, to decrease the operational thickness of cassette device 10, step 112 is achievable by disposing respectively inferior anterior slider 52 and inferior posterior slider 58 on second terminal portion 35 of inferior anterior rail 30 and second terminal portion 39 of inferior posterior rail 34, so that inferior anterior slider 52 and inferior posterior slider 58 are disposed vis-à-vis second terminal portion 35 of inferior anterior rail 30 and second terminal portion 39 of inferior posterior rail 34.

In some embodiments, such as shown in FIGS. 6B and 6B, decreasing an operational thickness of cassette device 10 facilitates the offsetting of plate 204 towards U-shaped anchoring profile 202 in the direction of arrow 66.

In some embodiments, method 100 of multidimensional plate alignment further proceeds to step 114 of regulating a second degree of freedom in position of plate 204 relative to U-shaped anchoring profile 202, by performing at least one longitudinal inclination of plate 204.

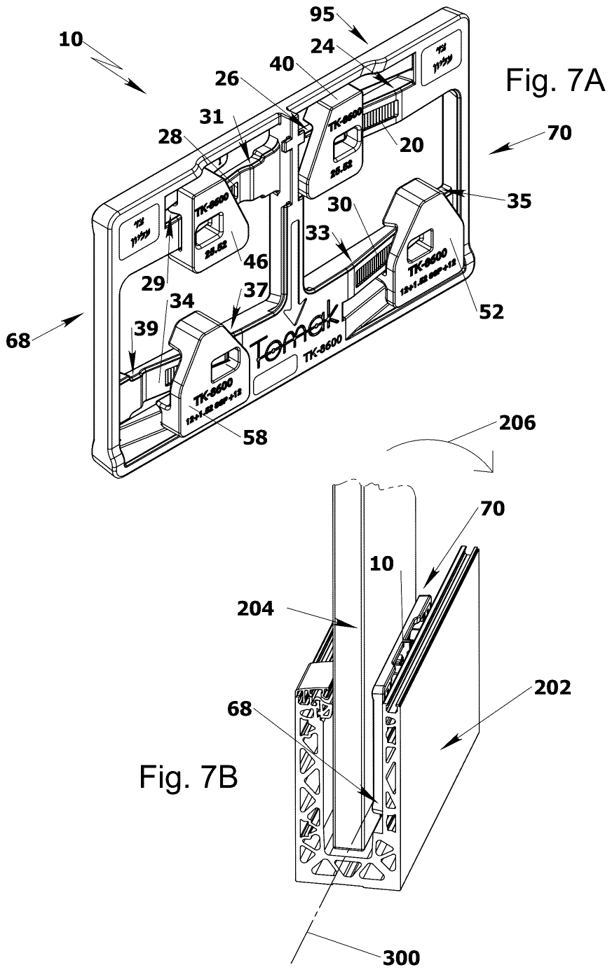

In some embodiments, such as shown in FIGS. 7A and 7B, to decrease the operational thickness of anterior portion 70 of cassette device 10, whilst concomitantly to increase the operational thickness of posterior portion 68 of cassette device 10, step 114 is achievable by disposing superior anterior slider 40 on second terminal portion 26 of superior anterior rail 20 and superior posterior slider 46 on first terminal portion 29 of superior posterior rail 28, so that superior anterior slider 40 is disposed vis-à-vis second terminal portion 26 of superior anterior rail 20, whereas superior posterior slider 46 is disposed vis-à-vis first terminal portion 29 of superior posterior rail 28.

In some embodiments, such as shown in FIGS. 7A and 7B, to decrease the operational thickness of anterior portion 70 of cassette device 10, whilst concomitantly to increase the operational thickness of posterior portion 68 of cassette device 10, step 114 is achievable by disposing inferior anterior slider 52 on second terminal portion 35 of inferior anterior rail 30 and inferior posterior slider 58 on first terminal portion 37 of superior posterior rail 34, so that inferior anterior slider 52 is disposed vis-à-vis second terminal portion 35 of inferior anterior rail 30, whereas inferior posterior slider 58 is disposed vis-à-vis first terminal portion 37 of superior posterior rail 34.

In some embodiments, such as shown in FIGS. 7B and 7B, decreasing the operational thickness of anterior portion 70 of cassette device 10, while concomitantly increasing the operational thickness of posterior portion 68 of cassette device 10, urges plate 204 for a right-sided longitudinal inclination in the direction of arrow 206 towards anterior portion 70 of cassette device 10, around longitudinal centerline 300 of U-shaped anchoring profile 202.

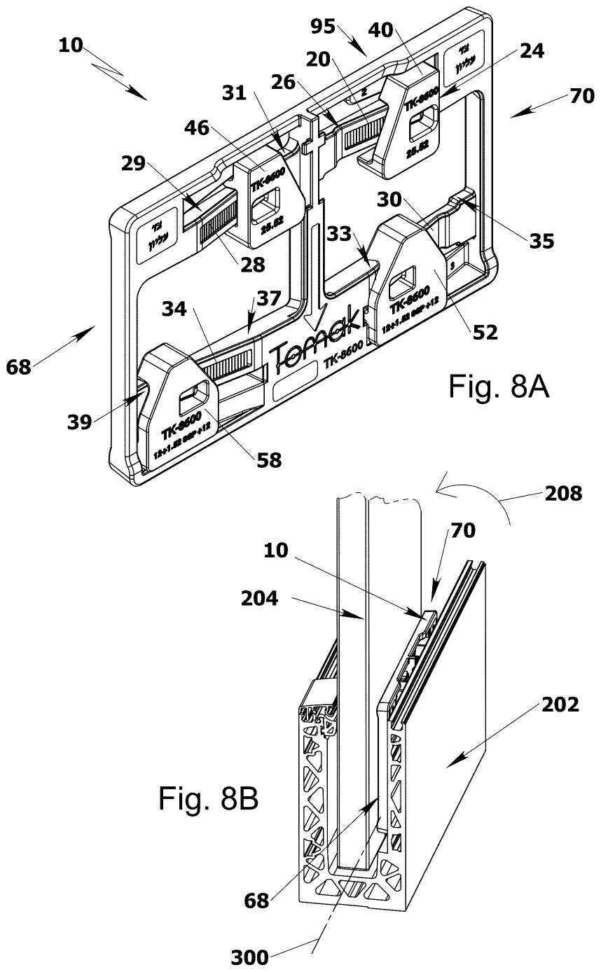

In some embodiments, such as shown in FIGS. 8A and 8B, to increase the operational thickness of anterior portion 70 of cassette device 10, whilst concomitantly to decrease the operational thickness of posterior portion 68 of cassette device 10, step 114 is achievable by disposing respectively superior anterior slider 40 and superior posterior slider 46 vis-à-vis first terminal portion 24 of superior anterior rail 20 and second terminal portion 31 of superior posterior rail 28, so that superior anterior slider 40 is disposed vis-à-vis first terminal portion 24 of superior anterior rail 20, whereas superior posterior slider 46 is disposed vis-à-vis second terminal portion 31 of superior posterior rail 28.

In some embodiments, such as shown in FIGS. 8A and 8B, to increase the operational thickness of anterior portion 70 of cassette device 10, whilst concomitantly to decrease the operational thickness of posterior portion 68 of cassette device 10, step 114 is achievable by disposing respectively inferior anterior slider 52 and inferior posterior slider 58 vis-à-vis first terminal portion 33 of inferior anterior rail 30 and second terminal portion 39 of superior posterior rail 34, so that inferior anterior slider 52 is disposed vis-à-vis first terminal portion 33 of inferior anterior rail 30, whereas inferior posterior slider 58 is disposed vis-à-vis second terminal portion 39 of superior posterior rail 34.

In some embodiments, such as shown in FIGS. 8A and 8B, increasing the operational thickness of anterior portion 70 of cassette device 10, while concomitantly decreasing the operational thickness of posterior portion 68 of cassette device 10, urges plate 204 for a left-sided longitudinal inclination in the direction of arrow 208 away from anterior portion 70 of cassette device 10, about longitudinal centerline 300 of U-shaped anchoring profile 202.

In some embodiments, method 100 of multidimensional plate alignment comprises step 116 of regulating a third degree of freedom in position of plate 204 relative to U-shaped anchoring profile 202, by performing at least one vertical tilt of plate 204.

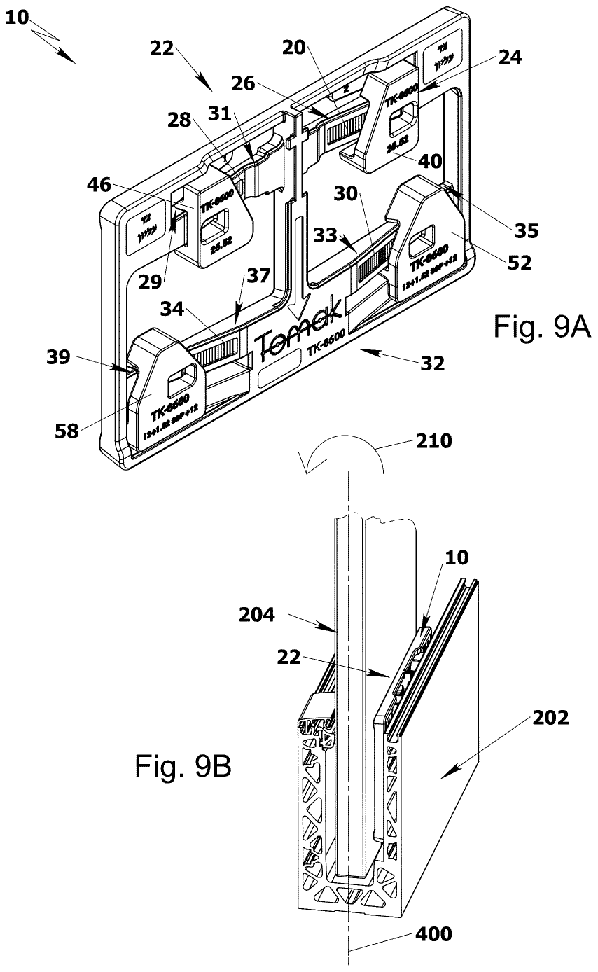

In some embodiments, as shown in FIGS. 9A and 9B, to increase the operational thickness of superior portion 22 of cassette device 10, whilst concomitantly to decrease the operational thickness of inferior portion 32 of cassette device 10, step 116 is achievable by disposing respectively superior anterior slider 40 and superior posterior slider 46 on first terminal portion 24 of superior anterior rail 20 and first terminal portion 29 of superior posterior rail 28, so that superior anterior slider 40 is disposed vis-à-vis first terminal portion 24 of superior anterior rail 20, whereas superior posterior slider 46 is disposed vis-à-vis first terminal portion 29 of superior posterior rail 28.

In some embodiments, such as shown in FIGS. 9A and 9B, to increase the operational thickness of superior portion 22 of cassette device 10, whilst concomitantly to decrease the operational thickness of inferior portion 32 of cassette device 10, step 116 is achievable by disposing respectively inferior anterior slider 52 and inferior posterior slider 58 on second terminal portion 35 of inferior anterior rail 30 and second terminal portion 39 of inferior posterior rail 34, so that inferior anterior slider 52 is disposed vis-à-vis second terminal portion 35 of inferior anterior rail 30, whereas inferior posterior slider 58 is disposed vis-à-vis second terminal portion 39 of inferior posterior rail 34.

In some embodiments, such as shown in FIGS. 9B and 9B, increasing the operational thickness of superior portion 22 of cassette device 10, while concomitantly decreasing the operational thickness of inferior portion 32 of cassette device 10, urges plate 204 for a vertical tilt in the direction of arrow 210 away from superior portion 22 of cassette device 10, about vertical centerline 400 of U-shaped anchoring profile 202.

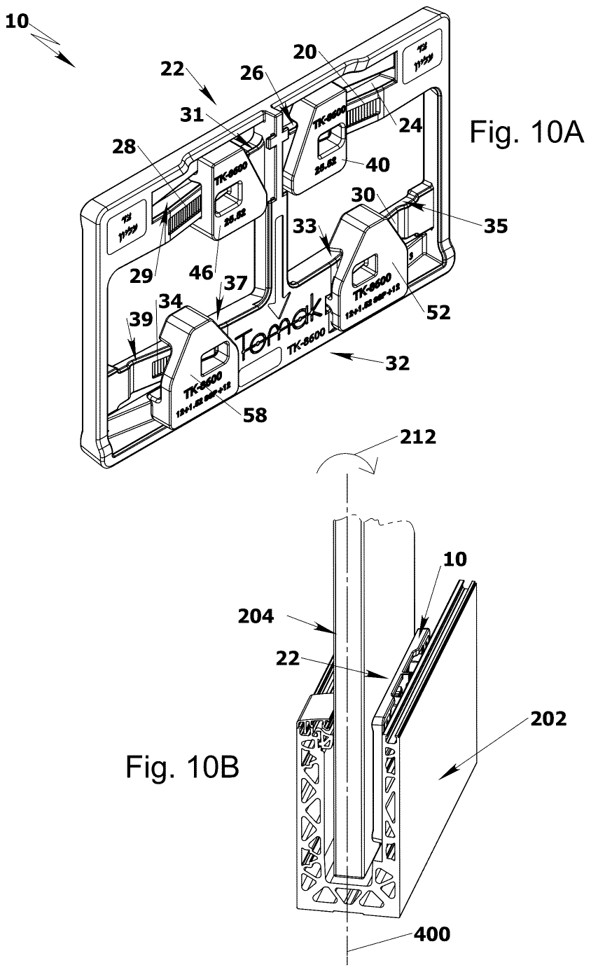

In some embodiments, as shown in FIGS. 10A and 10B, to decrease the operational thickness of superior portion 22 of cassette device 10, step 116 is achievable by disposing respectively superior anterior slider 40 and superior posterior slider 46 on second terminal portion 26 of superior anterior rail 20 and second terminal portion 31 of superior posterior rail 28, so that anterior slider 40 is disposed vis-à-vis second terminal portion 26 of superior anterior rail 20, whereas superior posterior slider 46 is disposed vis-à-vis second terminal portion 31 of superior posterior rail 28.

In some embodiments, as shown in FIGS. 10A and 10B, to increase the operational thickness of inferior portion 32 of cassette device 10, step 116 is achievable by disposing respectively inferior anterior slider 52 and inferior posterior slider 58 vis-à-vis first terminal portion 33 of inferior anterior rail 30 and first terminal portion 37 of inferior posterior rail 34, so that inferior anterior slider 52 is disposed vis-à-vis first terminal portion 33 of inferior anterior rail 30, whereas inferior posterior slider 58 is disposed vis-à-vis first terminal portion 37 of inferior posterior rail 34.

In some embodiments, as shown in FIGS. 10B and 10B, decreasing the operational thickness of superior portion 22 of cassette device 10, whilst concomitantly to increasing the operational thickness of inferior portion 32 of cassette device 10, urges plate 204 for a vertical tilt in the direction of arrow 212 towards superior portion 22 of cassette device 10, about vertical centerline 400 of U-shaped anchoring profile 202.

In some embodiments, step 112, 114 and 116 of regulating first, second and third degrees of freedom in position of plate 204 relative to U-shaped anchoring profile 202, further comprises connecting a biasing means to superior anterior slider 40, superior posterior slider 46, inferior anterior slider 52 and/or inferior posterior slider 58, to enhance friction and maintain a secure grip on plate 204.

In some embodiments, method 100 further comprises a step of securing plate 204 in U-shaped anchoring profile 202 using fasteners to maintain alignment during operation.

### INDEX OF REFERENCE NUMERALS

Within the specification hereinabove inter alia the following numerals were used to denote the particular constituents in the appended drawings:
10—cassette device
12—structural framework
14—anterior vertical member
16—posterior vertical member
18—median member
20—superior anterior rail
21—guide grooves
22—superior portion
24—superior anterior rail first terminal portion
26—superior anterior rail second terminal portion
28—superior posterior rail
29—superior posterior rail first terminal portion
30—inferior anterior rail
31—superior posterior rail second terminal portion
32—inferior portion
33—inferior anterior rail first terminal portion
34—inferior posterior rail
35—inferior anterior rail second terminal portion
37—inferior posterior rail first terminal portion
39—inferior posterior rail second terminal portion
40—superior anterior slider
42—superior anterior slider first terminal portion
44—superior anterior slider second terminal portion
46—superior posterior slider
48—superior posterior slider first terminal portion
50—superior posterior slider second terminal portion
52—inferior anterior slider
54—inferior anterior slider first terminal portion
56—inferior anterior slider second terminal portion
58—inferior posterior slider
60—inferior posterior slider first terminal portion
62—inferior posterior slider second terminal portion
64—directional arrow offsetting away from U-shaped profile
66—directional arrow offsetting towards U-shaped profile
68—posterior portion
70—anterior portion
100—multidimensional plate alignment method flowchart
102—providing a cassette device
104—providing a U-shaped anchoring profile
106—providing a plate
108—mounting the plate
110—disposing cassette device
112—regulating a first degree of freedom
114—regulating a second degree of freedom
116—regulating a third degree of freedom
206—directional arrow posterior-sided longitudinal inclination
208—directional arrow anterior-sided longitudinal inclination
210—directional arrow posterior-sided vertical tilt
212—directional arrow anterior-sided vertical tilt
300—longitudinal centerline of U-shaped anchoring profile
400—vertical centerline of U-shaped anchoring profile
It will be appreciated by persons skilled in the art of the invention that various features and/or elements elaborated in the context of a specific embodiment described hereinabove and/or referenced herein and/or illustrated by a particular example in a certain drawing enclosed hereto, whether method, system, device or product, is/are interchangeable with features and/or elements of any other embodiment described in the specification and/or shown in the drawings. Moreover, skilled persons would appreciate that the present invention is not limited by what has been particularly shown and described hereinabove. Rather the scope of the invention is defined by the claims which follow:

1. A method of multidimensional plate alignment comprises the steps of:
(a) providing a cassette device comprising:
(I) a structural framework made of an essentially rigid material comprising:
(i) an anterior vertical member, extending essentially an entire height on an anterior side of said structural framework;
(ii) a posterior vertical member, extending essentially an entire height on a posterior side of said structural framework;
(iii) a median member, extending essentially an entire height in a center of said structural framework;
(iv) a superior anterior rail, extending essentially in-between said median member and said anterior member, at a superior portion of said structural framework, said superior anterior rail comprising a slanted profile, wherein a first terminal portion of said superior anterior rail comprises a thickness substantially exceeding a thickness of a second terminal portion of said superior anterior rail;
(v) a superior posterior rail, extending essentially in-between said median member and said posterior member, at a superior portion of said structural framework, said superior posterior rail comprising a slanted profile, wherein a first terminal portion of said superior posterior rail comprises a thickness substantially exceeding a thickness of a second terminal portion of said superior posterior rail;
(vi) an inferior anterior rail, extending essentially in-between said median member and said anterior member, at an inferior portion of said structural framework, said inferior anterior rail comprising a slanted profile, wherein a first terminal portion of said inferior anterior rail comprises a thickness substantially exceeding a thickness of a second terminal portion of said inferior anterior rail;
(vii) an inferior posterior rail, extending essentially in-between said median member and said posterior member, at an inferior portion of said structural framework, said inferior posterior rail comprising a slanted profile, wherein a first terminal portion of said inferior posterior rail comprises a thickness substantially exceeding a thickness of a second terminal portion of said inferior posterior rail;
(II) a superior anterior slider, configured to slide on said superior anterior rail, said superior anterior slider comprising a slanted profile, wherein a first terminal portion of said superior anterior slider comprises a thickness substantially exceeding a thickness of a second terminal portion of said superior anterior slider; wherein said slanted profile of said superior anterior slider is essentially inverted relative to said slanted profile of said superior anterior rail;
(III) a superior posterior slider, configured to slide on said superior posterior rail, said superior posterior rail comprising a slanted profile, wherein a first terminal portion of said superior posterior slider comprises a thickness substantially exceeding a thickness of a second terminal portion of said superior posterior slider; wherein said slanted profile of said superior posterior slider is essentially inverted relative to said slanted profile of said superior posterior rail;
(IV) an inferior anterior slider, configured to slide on said inferior anterior rail, said inferior anterior rail comprising a slanted profile, wherein a first terminal portion of said inferior anterior slider comprises a thickness substantially exceeding a thickness of a second terminal portion of said inferior anterior slider; wherein said slanted profile of said inferior anterior slider is essentially inverted relative to said slanted profile of said inferior anterior rail;
(V) an inferior posterior slider, configured to slide on said inferior posterior rail, said inferior posterior rail comprising a slanted profile, wherein a first terminal portion of said inferior posterior slider comprises a thickness substantially exceeding a thickness of a second terminal portion of said inferior posterior slider; wherein said slanted profile of said inferior posterior slider is essentially inverted relative to said slanted profile of said inferior posterior rail;
(b) providing U-shaped anchoring profile;
(c) providing a plate;
(d) mounting said plate in said U-shaped anchoring profile;
(e) disposing said cassette device in-between said plate and said U-shaped anchoring profile;
(f) regulating a first degree of freedom in position of said plate relative to said U-shaped anchoring profile, by performing at least one offsetting selected from the group consisting of:
(I) disposing respectively said superior anterior slider and said superior posterior slider vis-à-vis said first terminal portion of superior anterior rail and said second terminal portion of superior posterior rail and disposing respectively said inferior anterior slider and said inferior posterior slider vis-à-vis said first terminal portion of said inferior anterior rail and said second terminal portion of said inferior posterior rail, to increase an operational thickness of said cassette device, thereby offsetting said plate away from said U-shaped anchoring profile, and
(II) disposing respectively said superior anterior slider and said superior posterior slider vis-à-vis said second terminal portion of said superior anterior rail and said second terminal portion of said superior posterior rail and disposing respectively said inferior anterior slider and said inferior posterior slider vis-à-vis said second terminal portion of said inferior anterior rail and said second terminal portion of said inferior posterior rail, to decrease said operational thickness of said cassette device, thereby offsetting said plate towards said U-shaped anchoring profile;
(g) regulating a second degree of freedom in position of said plate relative to said U-shaped anchoring profile, by performing at least one longitudinal inclination selected from the group consisting of:
(I) disposing respectively said superior anterior slider and said superior posterior slider vis-à-vis said second terminal portion of said superior anterior rail and said first terminal portion of said superior posterior rail and disposing respectively said inferior anterior slider and said inferior posterior slider vis-à-vis said second terminal portion of said inferior anterior rail and said first terminal portion of said superior posterior rail, to increase said operational thickness of an anterior portion of said cassette device, whilst concomitantly to decrease said operational thickness of a posterior portion of said cassette device, thereby urging said plate for a longitudinal inclination away from said anterior portion of said cassette device, about said longitudinal centerline of said U-shaped anchoring profile, and
(II) disposing respectively said superior anterior slider and said superior posterior slider vis-à-vis said first terminal portion of said superior anterior rail and said second terminal portion of said superior posterior rail and disposing respectively said inferior anterior slider and said inferior posterior slider vis-à-vis said first terminal portion of said inferior anterior rail and said second terminal portion of said superior posterior rail, to decrease operational thickness of said anterior portion of said cassette device, whilst concomitantly to increase said operational thickness of said posterior portion of said cassette device, thereby urging said plate for a longitudinal inclination towards said anterior portion of said cassette device, about said longitudinal centerline of said U-shaped anchoring profile;
(h) regulating a third degree of freedom in position of said plate relative
to said U-shaped anchoring profile, by performing at least one vertical tilt selected from the group consisting of:
(I) disposing respectively said superior anterior slider and said superior posterior slider vis-à-vis said first terminal portion of said superior anterior rail and said second terminal portion of said superior posterior rail and disposing respectively said inferior anterior slider and said inferior posterior slider vis-à-vis said second terminal portion of said inferior anterior rail and said second terminal portion of said inferior posterior rail, to increase said operational thickness of a superior portion of said cassette device, whilst concomitantly to decrease said operational thickness of an inferior portion of said cassette device, thereby urging said plate for a vertical tilt away from said superior portion of said cassette device, about a vertical centerline of said plate;
(II) disposing respectively said superior anterior slider and said superior posterior slider vis-à-vis said second terminal portion of said superior anterior rail and said second terminal portion of said superior posterior rail and disposing respectively said inferior anterior slider and said inferior posterior slider vis-à-vis said first terminal portion of said inferior anterior rail and said first terminal portion of said superior posterior rail, to decrease said operational thickness of said superior portion of said cassette device, whilst concomitantly to increase said operational thickness of said inferior portion of said cassette device, thereby urging said plate for a vertical tilt towards from said superior portion of said cassette device, about said vertical centerline of said plate.

2. The method as in claim 1, wherein said rails further comprise guide grooves, stabilizing said sliders and configured to prevent lateral movement thereof on said rails.

3. The method as in claim 1, wherein said slanted profiles of said sliders and/or said rails comprise a self-locking mechanism, configured to secure said sliders in place during use.

4. The method as in claim 1, wherein said rails further comprise at least one end stopper, configured to prevent said sliders from sliding off said rails.

5. The method as, in claim 1, further comprises securing said plate in said U-shaped anchoring profile, by using fasteners to maintain alignment during operation.

6. The method as, in claim 1, further comprises connecting a biasing means to at least one member selected from the group consisting of: said superior anterior slider, said superior posterior slider, said inferior anterior slider and said inferior posterior slider, configured to provide friction and maintain a secure grip on said plate.

7. The method as in claim 1, wherein said slanted profiles of said superior rails are oriented essentially invertedly, wherein said both first terminal portions of said superior rails are disposed either towards said median member or away from said median member.

8. The method as in claim 1, wherein said slanted profiles of said inferior rails are oriented essentially invertedly, wherein said both first terminal portions of said inferior rails are disposed either towards said median member or away from said median member.

9. The method as in claim 1, wherein said slanted profiles of said anterior rails are oriented essentially invertedly, wherein said first terminal portion of said superior anterior rail and said second portion of said superior anterior rail are disposed either towards said median member or towards said anterior member.

10. The method as in claim 1, wherein said slanted profiles of said posterior rails are oriented essentially invertedly, wherein said first terminal portion of said superior posterior rail and said second portion of said superior posterior rail are disposed either towards said median member or towards said posterior member.

11. A plate assembly with multidimensional alignment comprises:
(a) a U-shaped anchoring profile;
(b) a plate mounted in said plate in said U-shaped anchoring profile;
(c) a cassette device disposed in-between said plate and said U-shaped anchoring profile comprising:
(I) a structural framework made of an essentially rigid material comprising:
(i) an anterior vertical member, extending essentially an entire height on an anterior side of said structural framework;
(ii) a posterior vertical member, extending essentially an entire height on a posterior side of said structural framework;
(iii) a median member, extending essentially an entire height in a center of said structural framework;
(iv) a superior anterior rail, extending essentially in-between said median member and said anterior member, at a superior portion of said structural framework, said superior anterior rail comprising a slanted profile, wherein a first terminal portion of said superior anterior rail comprises a thickness substantially exceeding a thickness of a second terminal portion of said superior anterior rail;
(v) a superior posterior rail, extending essentially in-between said median member and said posterior member, at a superior portion of said structural framework, said superior posterior rail comprising a slanted profile, wherein a first terminal portion of said superior posterior rail comprises a thickness substantially exceeding a thickness of a second terminal portion of said superior posterior rail;
(vi) an inferior anterior rail, extending essentially in-between said median member and said anterior member, at an inferior portion of said structural framework, said inferior anterior rail comprising a slanted profile, wherein a first terminal portion of said inferior anterior rail comprises a thickness substantially exceeding a thickness of a second terminal portion of said inferior anterior rail;
(vii) an inferior posterior rail, extending essentially in-between said median member and said posterior member, at an inferior portion of said structural framework, said inferior posterior rail comprising a slanted profile, wherein a first terminal portion of said inferior posterior rail comprises a thickness substantially exceeding a thickness of a second terminal portion of said inferior posterior rail;
(II) a superior anterior slider, configured to slide on said superior anterior rail, said superior anterior slider comprising a slanted profile, wherein a first terminal portion of said superior anterior slider comprises a thickness substantially exceeding a thickness of a second terminal portion of said superior anterior slider; wherein said slanted profile of said superior anterior slider is essentially inverted relative to said slanted profile of said superior anterior rail;
(III) a superior posterior slider, configured to slide on said superior posterior rail, said superior posterior rail comprising a slanted profile, wherein a first terminal portion of said superior posterior slider comprises a thickness substantially exceeding a thickness of a second terminal portion of said superior posterior slider; wherein said slanted profile of said superior posterior slider is essentially inverted relative to said slanted profile of said superior posterior rail;
(IV) an inferior anterior slider, configured to slide on said inferior anterior rail, said inferior anterior rail comprising a slanted profile, wherein a first terminal portion of said inferior anterior slider comprises a thickness substantially exceeding a thickness of a second terminal portion of said inferior anterior slider; wherein said slanted profile of said inferior anterior slider is essentially inverted relative to said slanted profile of said inferior anterior rail;
(V) an inferior posterior slider, configured to slide on said inferior posterior rail, said inferior posterior rail comprising a slanted profile, wherein a first terminal portion of said inferior posterior slider comprises a thickness substantially exceeding a thickness of a second terminal portion of said inferior posterior slider; wherein said slanted profile of said inferior posterior slider is essentially inverted relative to said slanted profile of said inferior posterior rail;
(d) wherein a first degree of freedom in position of said plate relative to said U-shaped anchoring profile is regulatable, by performing at least one offsetting selected from the group consisting of:
(I) disposing respectively said superior anterior slider and said superior posterior slider vis-à-vis said first terminal portion of superior anterior rail and said second terminal portion of superior posterior rail, and disposing respectively said inferior anterior slider and said inferior posterior slider vis-à-vis said first terminal portion of said inferior anterior rail and said second terminal portion of said inferior posterior rail, to increase an operational thickness of said cassette device, thereby offsetting said plate away from said U-shaped anchoring profile, and
(II) disposing respectively said superior anterior slider and said superior posterior slider vis-à-vis said second terminal portion of said superior anterior rail and said second terminal portion of said superior posterior rail and disposing respectively said inferior anterior slider and said inferior posterior slider vis-à-vis said second terminal portion of said inferior anterior rail and said second terminal portion of said inferior posterior rail, to decrease said operational thickness of said cassette device, thereby offsetting said plate towards said U-shaped anchoring profile;
(e) wherein a first degree of freedom in position of said plate relative to said U-shaped anchoring profile is regulatable, by performing at least one longitudinal inclination selected from the group consisting of:
(I) disposing respectively said superior anterior slider and said superior posterior slider vis-à-vis said second terminal portion of said superior anterior rail and said first terminal portion of said superior posterior rail and disposing respectively said inferior anterior slider and said inferior posterior slider vis-à-vis said second terminal portion of said inferior anterior rail and said first terminal portion of said superior posterior rail, to increase said operational thickness of an anterior portion of said cassette device, whilst concomitantly to decrease said operational thickness of a posterior portion of said cassette device, thereby urging said plate for a longitudinal inclination away from said anterior portion of said cassette device, about said longitudinal centerline of said U-shaped anchoring profile, and
(II) disposing respectively said superior anterior slider and said superior posterior slider vis-à-vis said first terminal portion of said superior anterior rail and said second terminal portion of said superior posterior rail and disposing respectively said inferior anterior slider and said inferior posterior slider vis-à-vis said first terminal portion of said inferior anterior rail and said second terminal portion of said superior posterior rail, to decrease operational thickness of said anterior portion of said cassette device, whilst concomitantly to increase said operational thickness of said posterior portion of said cassette device, thereby urging said plate for a longitudinal inclination towards said anterior portion of said cassette device, about said longitudinal centerline of said U-shaped anchoring profile;
(f) wherein a first degree of freedom in position of said plate relative to said U-shaped anchoring profile is regulatable, by performing at least one vertical tilt selected from the group consisting of:
(I) disposing respectively said superior anterior slider and said superior posterior slider vis-à-vis said first terminal portion of said superior anterior rail and said second terminal portion of said superior posterior rail and disposing respectively said inferior anterior slider and said inferior posterior slider vis-à-vis said second terminal portion of said inferior anterior rail and said second terminal portion of said inferior posterior rail, to increase said operational thickness of a superior portion of said cassette device, whilst concomitantly to decrease said operational thickness of an inferior portion of said cassette device, thereby urging said plate for a vertical tilt away from said superior portion of said cassette device, about a vertical centerline of said plate;
(II) disposing respectively said superior anterior slider and said superior posterior slider vis-à-vis said second terminal portion of said superior anterior rail and said second terminal portion of said superior posterior rail and disposing respectively said inferior anterior slider and said inferior posterior slider vis-à-vis first terminal portion of said inferior anterior rail and said first terminal portion of said superior posterior rail, to decrease said operational thickness of said superior portion of said cassette device, whilst concomitantly to increase said operational thickness of said inferior portion of said cassette device, thereby urging said plate for a vertical tilt towards from said superior portion of said cassette device, about said vertical centerline of said plate.

12. The assembly as in claim 11, wherein said rails further comprise guide grooves, stabilizing said sliders and configured to prevent lateral movement thereof on said rails.

13. The assembly as in claim 11, wherein said slanted profiles of said sliders and/or said rails comprise a self-locking mechanism, configured to secure said sliders in place during use.

14. The assembly as in claim 11, wherein said rails further comprise at least one end stopper, configured to prevent said sliders from sliding off said rails.

15. The assembly as in claim 11, further comprises a biasing means on at least one member selected from the group consisting of: said superior anterior slider, said superior posterior slider, said inferior anterior slider and said inferior posterior slider, configured to provide friction and maintain a secure grip on said plate.

16. The assembly as in claim 11, wherein at least one of the following is held true:
(a) said slanted profiles of said superior rails are oriented essentially invertedly, wherein said both first terminal portions of said superior rails are disposed either towards said median member or away from said median member.
(b) said slanted profiles of said inferior rails are oriented essentially invertedly, wherein said both first terminal portions of said inferior rails are disposed either towards said median member or away from said median member.
(c) said slanted profiles of said anterior rails are oriented essentially invertedly, wherein said first terminal portion of said superior anterior rail and said second portion of said superior anterior rail are disposed either towards said median member or towards said anterior member.
(d) said slanted profiles of said posterior rails are oriented essentially invertedly, wherein said first terminal portion of said superior posterior rail
and said second portion of said superior posterior rail are disposed either towards said median member or towards said posterior member.

17. A cassette device for multidimensional plate alignment comprises:
(a) a structural framework made of an essentially rigid material comprising:
(I) an anterior vertical member, extending essentially an entire height on an anterior side of said structural framework;
(II) a posterior vertical member, extending essentially an entire height on a posterior side of said structural framework;
(III) a median member, extending essentially an entire height in a center of said structural framework;
(IV) a superior anterior rail, extending essentially in-between said median member and said anterior member, at a superior portion of said structural framework, said superior anterior rail comprising a slanted profile, wherein a first terminal portion of said superior anterior rail comprises a thickness substantially exceeding a thickness of a second terminal portion of said superior anterior rail;
(V) a superior posterior rail, extending essentially in-between said median member and said posterior member, at a superior portion of said
structural framework, said superior posterior rail comprising a slanted profile, wherein a first terminal portion of said superior posterior rail comprises a thickness substantially exceeding a thickness of a second terminal portion of said superior posterior rail;
(VI) an inferior anterior rail, extending essentially in-between said median member and said anterior member, at an inferior portion of said structural framework, said inferior anterior rail comprising a slanted profile, wherein a first terminal portion of said inferior anterior rail comprises a thickness substantially exceeding a thickness of a second terminal portion of said inferior anterior rail;
(VII) an inferior posterior rail, extending essentially in-between said median member and said posterior member, at an inferior portion of said structural framework, said inferior posterior rail comprising a slanted profile, wherein a first terminal portion of said inferior posterior rail comprises a thickness substantially exceeding a thickness of a second terminal portion of said inferior posterior rail;
(b) a superior anterior slider, configured to slide on said superior anterior rail, said superior anterior slider comprising a slanted profile, wherein a first terminal portion of said superior anterior slider comprises a thickness substantially exceeding a thickness of a second terminal portion of said superior anterior slider; wherein said slanted profile of said superior anterior slider is essentially inverted relative to said slanted profile of said superior anterior rail;
(c) a superior posterior slider, configured to slide on said superior posterior rail, said superior posterior rail comprising a slanted profile, wherein a first terminal portion of said superior posterior slider comprises a thickness substantially exceeding a thickness of a second terminal portion of said superior posterior slider; wherein said slanted profile of said superior posterior slider is essentially inverted relative to said slanted profile of said superior posterior rail;
(d) an inferior anterior slider, configured to slide on said inferior anterior rail, said inferior anterior rail comprising a slanted profile, wherein a first terminal portion of said inferior anterior slider comprises a thickness substantially exceeding a thickness of a second terminal portion of said inferior anterior slider; wherein said slanted profile of said inferior anterior slider is essentially inverted relative to said slanted profile of said inferior anterior rail;
(e) an inferior posterior slider, configured to slide on said inferior posterior rail, said inferior posterior rail comprising a slanted profile, wherein a first terminal portion of said inferior posterior slider comprises a thickness substantially exceeding a thickness of a second terminal portion of said inferior posterior slider; wherein said slanted profile of said inferior posterior slider is essentially inverted relative to said slanted profile of said inferior posterior rail.

18. The cassette device as in claim 17, wherein said rails further comprise guide grooves, stabilizing said sliders and configured to prevent lateral movement thereof on said rails.

19. The cassette device as in claim 17, wherein said slanted profiles of said sliders and/or said rails comprise a self-locking mechanism, configured to secure said sliders in place during use.

20. The cassette device as in claim 17, wherein at least one of the following is held true:
(a) said slanted profiles of said superior rails are oriented essentially invertedly, wherein said both first terminal portions of said superior rails are disposed either towards said median member or away from said median member.
(b) said slanted profiles of said inferior rails are oriented essentially invertedly, wherein said both first terminal portions of said inferior rails are disposed either towards said median member or away from said median member.
(c) said slanted profiles of said anterior rails are oriented essentially invertedly, wherein said first terminal portion of said superior anterior rail and said second portion of said superior anterior rail are disposed either
towards said median member or towards said anterior member.
(d) said slanted profiles of said posterior rails are oriented essentially invertedly, wherein said first terminal portion of said superior posterior rail and said second portion of said superior posterior rail are disposed either towards said median member or towards said posterior member.
